(19) United States
(12) Patent Application Publication
(10) Pub. No.: US 2018/0365000 A1
(43) Pub. Date: Dec. 20, 2018

(54) REPROGRAMMING ACCESS POINTS

(71) Applicant: Aruba Networks, Inc., Sunnyvale, CA (US)

(72) Inventor: Yan Liu, Beijing (CN)

(21) Appl. No.: 15/781,139

(22) PCT Filed: Dec. 4, 2015
(86) PCT No.: PCT/US2015/064108

§ 371 Date: Jun. 3, 2018

(51) Int. Cl. G06F 8/65; H04W 24/02

(52) U.S. Cl. CPC G06F 8/65; G06F 9/4401; H04W 24/02

(57) ABSTRACT

In some examples, a method may include detecting, by a master access point of a cluster of access points, a new access point programmed with a second code version, where the master access point is programmed with a first code version that is older than the second code version. The method may also include determining whether the master access point can be reprogrammed with the second code version, and based on a determination that the master access point can be reprogrammed with the second code version, reprogramming the master access point with the second code version, and rebooting the master access point after sending to the new access point a command to change configuration of the new access point.

### BACKGROUND

A wireless local area network (WLAN) is a wireless computer network that links two or more devices using a wireless distribution method within a limited area such as a home, school, or an office building. A WLAN can include a number of access points (e.g., wireless routers) that can transmit and receive radio frequencies to and from wireless enabled client devices, such as laptops, desktops, smartphones, and so forth.

### BRIEF DESCRIPTION OF THE DRAWINGS

The following detailed description references the drawings, wherein:

FIG. 1 is a block diagram of an example access point;

FIG. 2 is a block diagram of an example cluster of access points, a new access point, and a server;

FIG. 3 shows a flowchart of an example method; and

FIG. 4 is a block diagram of an example computing device.

### DETAILED DESCRIPTION

To facilitate configuration and maintenance of the various access points, a number of access points may be grouped into a cluster, where all access points in the same cluster may communicate with each other and automatically adjust their configuration (e.g., their server set identifier (SSID) configuration) to match the configuration of the other access points. One of the cluster's access points may serve as a master access point and be responsible for performing various networking functions on behalf of other (“slave”) access points in the cluster. In some implementations, when a configuration (e.g., SSID configuration) of the master access point changes, the slave access points may detect the change and automatically update their configurations to match the configuration of the master access point. This may allow the user to update the configuration of the entire cluster of access points by updating the configuration of the master access point, In some implementations, the user may seamlessly add a new access point to the cluster of access points. For example, the user may power up a new access point, which may automatically communicate with the cluster's access points, identify the master access point, and join the cluster.

Each access point may be programmed with code (e.g., software and/or firmware) which, when executed by one or more processors of the access point, may perform various functions of the access point, discussed in more detail below. The code may be of a particular version (e.g., 1.0, 1.2, etc.), and may be updated to a newer version, where the newer version may fix bugs, support new hardware, support new features, and so forth. In some implementations, in order for the cluster function properly, it may be desirable that all access points are programmed with the same code version. Thus, when a new access point programmed with a first code version point joins a cluster of access points programmed with a second code version, it may be desirable that either the new access point be reprogrammed with the second code version or that the existing access points of the cluster be reprogrammed with the first code version.

Sometimes, however, a particular access point may not be reprogrammed with a particular code version, for example, if that code version does not support the hardware of the particular access point. For example, newer models of access points may include new hardware which may not be supported by older code versions, such as code versions below a certain minimum version.

Examples disclosed herein discuss, among other things, an access point programmed with a first code version. The access point may include a communication interface, which may communicate with a second access point programmed with a second code version, and obtain the second code version from the second access point. The access point may further include a code upgrade module, which may determine, based at least on the first code version and the second version, whether the access point is to be upgraded to the second code version. The code upgrade module may also determine, based on a determination that the access point is to be upgraded, whether upgrade of the access point is enabled, and based on a determination that the access point is to be upgraded and that the upgrade of the access point is enabled, reprogram the access point with the second code version, and reboot the access point. The communication interface may also send to the second access point a command to change configuration of the second access point.

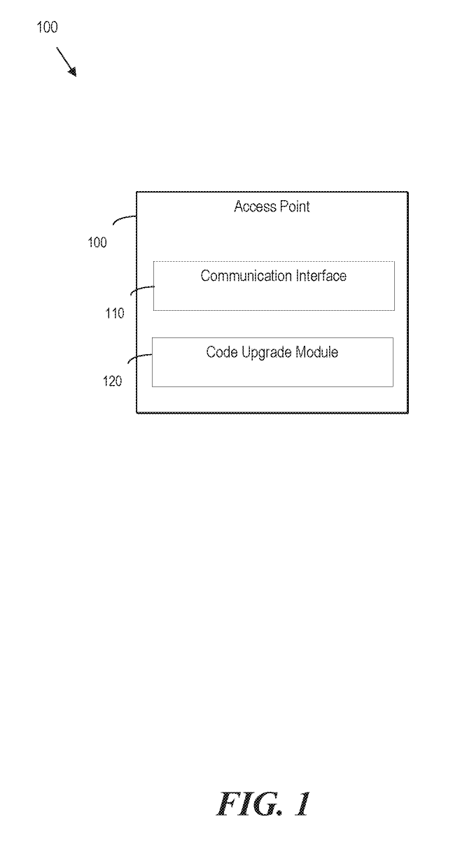

FIG. 1 is a block diagram of an example access point 100. Access point 100 may be any kind of a wireless device, such as an IEEE 802.11 (“Wi-Fi”) router, or any other electronic device or a combination of electronic devices capable of transmitting and receiving radio frequencies to and from client devices (e.g., laptops, desktops, smartphones, etc.) and/or other access points. Access point 100 may include, for example, a communication interface 110 and a code upgrade module 120. Communication interface 110 may include, among other things, a wireless receiver and a wireless transmitter, and may be implemented using any combination of hardware and programming. Similarly, code upgrade module 120 may be implemented using any combination of hardware and programming, as will be discussed in more detail below.

Access point may also include a memory (not shown for brevity) that may include any combination of volatile and non-volatile memories of any types. For example, the memory may include any combination of random-access memories (RAMS), flash memories, hard drives, memristor-based memories, and the like. In some implementation, the memory may store code (e.g., firmware, software, etc.) that may include a set of instructions, which, when executed by a processor of access point 100 (not shown in FIG. 1 for brevity) may implement some or all of the functionality of communication interface 110, code upgrade module 120, and/or any other modules of access point 100. The processor may include a number of processors, such as central processing units (CPUs), semiconductor-based microprocessors, graphics processing units (GPUs), field-programmable gate arrays (FPGAs), or any other types of processors.

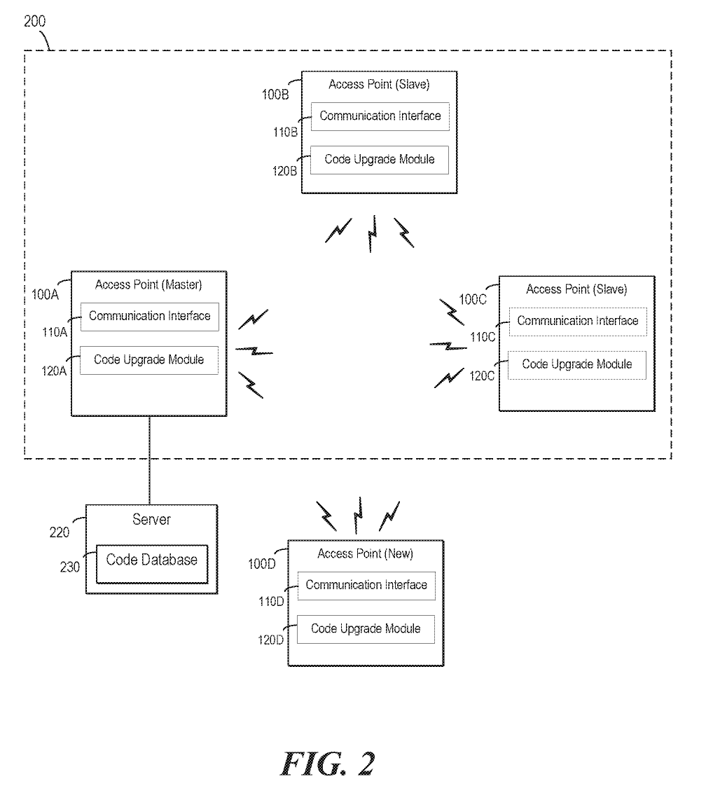

FIG. 2 shows an example cluster 200 that includes access points 100A, 100B, and 100C, and also shows a new access point 100D attempting to join cluster 200. In the example of FIG. 2, access point 100A has been elected as the master access point, meaning that access points 100E and 100C can be referred to as slave secondary access points. As mentioned above, master access point 100A may be responsible for managing various the networking functions on behalf of the entire cluster. For example, the user may configure master access point 100A (e.g., configure its SSID parameters) and the configuration, referred herein as the master configuration, may apply to all access points 100 of cluster 200. As will be discussed below, access points 100 of cluster 200 may periodically or at certain events (e.g., after rebooting) may elect another access point (e.g., 100B) as the master access point of the cluster. In some implementations, electing a new master access point may not change the master configuration. For example, the new master access point may automatically copy the configuration of the previous master access point,

The example of FIG. 2 further illustrates a server 220 communicatively coupled to master access point 100A. Server 220 may be any type of computing device or a number of computing devices communicatively coupled (e.g., via one or more networks such as the Internet) to master access point 100A. In some implementations, not shown for brevity, other access points (e.g., 100B, 100C, and 100D) can also be communicatively coupled to server 220. Server 220 may store a code database 230 that may include a number of code versions, i.e., a number of different versions of code that can be downloaded to and executed by various access points 100.

In some implementations, when new access point 100D is powered up and is connected to cluster 200 (e.g., wirelessly or via a wired connection such as LAN), it may communicate with some or all access points 100 within cluster 200, and may determine based on the communications (e.g., based on a communication from communication interface 110A of access point 100A) that access point 100A is the master access point of the cluster.

Similarly, master access point 100A may detect communications from new access point 100D and determine that new access point 100D is currently not a part of cluster 200. In some implementations, master access point 100A may then communicate with new access point 100D (e.g., via communication interface 110A and communication interface 110D) to determine whether and how new access point 100D can be added to the cluster. As part of these communications, master access point 100A may request and obtain from new access point 100D its current code version, i.e., the version of code with which new access point 100D is currently programmed.

Master access point 100A may then determine, e.g., using code upgrade module 120A, whether the code versions of at least one of access points 100A, 100B, 100C, or 100D need to be updated, i.e., upgraded to a newer version or downgraded to an older version. As discussed above, in some implementations, for the cluster to function properly, all access points within a cluster may need to have the same code version. Accordingly, in such implementations, new access point 100D may be added to the cluster if its code version can match the code versions of all access points within the cluster.

Specifically, code upgrade module 120A of master access point 100A may determine whether the code version of master access point 100A needs to be upgraded. To make this determination, in some implementations module 120A may determine whether the code version of new access point 100D is greater than the code version of master access point 100A (and therefore is also greater than the code versions of other access points in the cluster having the same code version as the master access point). In some implementations, based on a determination that the code version of new access point 100D is greater (i.e., newer) than the code version of master access point 100A, module 120A may determine that the upgrade of master access point 100A is needed. In other implementations, module 120A may determine that the upgrade is needed based also on a determination that new access point 100D cannot be downgraded to the code version of master access point 100A, e.g., if new access point 100D is a newer model having new hardware that is not supported by the older code version of master access point 100A. Module 120 may make this additional determination, for example, by inquiring new access point 100D about the minimal code version supported by it.

If module 120A determines that the code version of master access point 100A is to be upgraded, module 120A may then determine whether the upgrade is possible or “enabled.” In some implementations, determining whether the upgrade is enabled may include determining whether code (e.g., software and/or firmware) corresponding to the code version of new access point 100D is available, e.g., whether the code can be downloaded to master access point 100A from another device, such as server 220. Thus, in some implementations, code upgrade module 120A may instruct (e.g., communication interface 110A) that the code be downloaded, after which module 120A may determine that the upgrade is enabled based on a determination that the code was successfully downloaded to master access point 100A and stored in its memory.

Alternatively or in addition, determining whether the upgrade is enabled may include determining whether a user-configurable setting indicates that the upgrade of the access point is allowed. That is, the user may configure a setting that indicates whether the master access point (e.g., 100A) is to upgrade its code version when a new access point (e.g., 100D) having a higher code version is joining the cluster. In such a case, code upgrade module 120A may determine that the upgrade is enabled only if the setting allows it.

Alternatively or in addition, determining whether the upgrade is enabled may include determining whether at least one access point in the cluster (e.g., 100A, 100B, or 100C) cannot be upgraded to the code version of new access point 100D, for example, because it does not support upgrades at all, or because it does not support the newer code version (e.g., if the newer code version is not backward compatible and does not support some older access point models).

If code upgrade module 120A determines that master access point 100A is to be upgraded and that the upgrade is enabled, code upgrade module 120A may reprogram master access point 100A with new code corresponding to the code version of new access point 100D. The reprogramming may include, for example, downloading the code from code database 230 stored on server 220, and replacing (e.g., rewriting) the existing code stored in the memory of master access point 100A with the downloaded code. After replacing the code, to complete the reprogramming, code upgrade module 120A may cause master access point 100A to reboot. After rebooting, master access point 100A may automatically run the new version of code, i.e., the same code that runs on new access point 100D. In some implementations, reprogramming and rebooting master access point 100A may not change the configuration (e.g., the SSID configuration) of master access point 100A.

In some examples, during or after the reprogramming of master access point 100A, any access point in cluster 200 (e.g., 100B and/or 100C) may determine, based on communications with master access point 100A, that the code version of master access point 100A is changing or has already changed to a version different from the code version of the access point. In such a case, the access point may obtain the new code version (e.g., from master access point 100A or from server 220), reprogram itself with the new code version (e.g., by storing the new code in its respective memory), and reboot,

In some implementations, after at least one access points 100 in cluster 200 is rebooted, access points 100 may collectively or individually perform the master election process, during which a new access point may be elected as the master access point. Electing a new master access point within the cluster may not change the master configuration associated because, for example, all access points within the cluster automatically copy the configuration of the currently elected master access point (e.g., 100A). However, if new access point 100D is elected as the new master access point (e.g., during the election process performed after master access point 100A is rebooted), its configuration may be different from the previous master configuration.

To avoid this undesirable scenario, in some implementations, before rebooting the access point (e.g., before, after, or during reprogramming the access point), communication interface 110A may send to new access point 100D a command to change the configuration of new access point 100D and thereby prevent modification of the master configuration. In some implementations, the command may include a command (or a number of commands) causing new access point 100D to copy the configuration of master access point 100A. Thus, even if new access point 100D is elected as the new master access point, the master configuration will be preserved. In other implementations, the command sent to new access point 100D may include a command (or a number of commands) causing new access point 100D to reset to default factory settings. In those implementations, the master election process may be configured not to elect an access point having default factory settings as the master access point. Thus, new access point 100D, after being reset to factory settings may not be elected as the new master access point and thereby change the master configuration.

As discussed above, communication interface 110A and code upgrade module 120 may each be implemented as any combination of hardware and programming. For example, the programming may include processor-executable instructions stored on a tangible, non-transitory computer-readable medium, and the hardware may include a processing resource for executing those instructions. The processing resource, for example, may include one or multiple processors (e.g., central processing units (CPUs), semiconductor-based microprocessors, graphics processing units (GPUs), field-programmable gate arrays (FPGAs) configured to retrieve and execute instructions, or other electronic circuitry), which may be integrated in a single device or distributed across devices. The computer-readable medium can be said to store program instructions that when executed by the processor resource implement the functionality of the respective component. The computer-readable medium may be integrated in the same device as the processor resource or it may be separate but accessible to that device and the processor resource. In one example, the program instructions can be part of an installation package that when installed can be executed by the processor resource to implement the corresponding component. In this case, the computer-readable medium may be a portable medium such as a CD, DVD, or flash drive or a memory maintained by a server from which the installation package can be downloaded and installed. In another example, the program instructions may be part of an application or applications already installed, and the computer-readable medium may include integrated memory such as a hard drive, solid state drive, or the like. In another example, the engines may be implemented by hardware logic in the form of electronic circuitry, such as application specific integrated circuits.

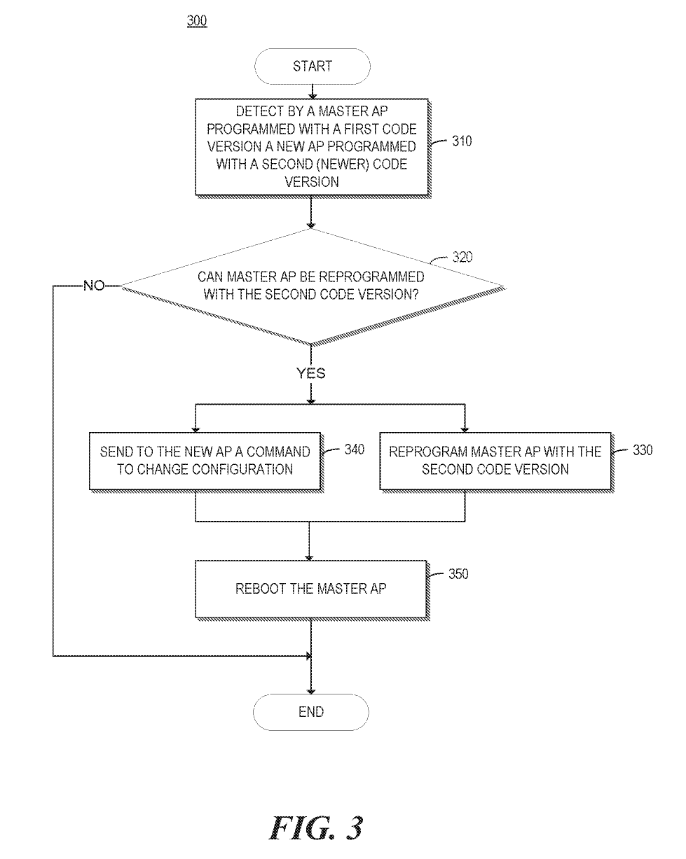

FIG. 3 is a flowchart of an example method 300 for reprogramming access points. Method 300 may be described below as being executed or performed by a system or by one or more devices such as an access point 100 (e.g., master access point 100A). Other suitable systems and/or computing devices may be used as well. Method 300 may be implemented in the form of executable instructions stored on at least one non-transitory machine-readable storage medium of the system and executed by at least one processor of the system. Alternatively or in addition, method 300 may be implemented in the form of electronic circuitry (e.g., hardware). In alternate examples of the present disclosure, one or more blocks of method 300 may be executed substantially concurrently or in a different order than shown in FIG. 3. In alternate examples of the present disclosure, method 300 may include more or less blocks than are shown in FIG. 3. In some examples, one or more of the blocks of method 300 may, at certain times, be ongoing and/or may repeat.

At block 310, the method may detect (e.g., by a master access point of a cluster of access points) a new access point (AP) programmed with a second code version, where the master access point is programmed with a first code version that is older than the second code version. At block 320, the method may determine whether the master access point can be reprogrammed with the second code version, i.e., where upgrade of the master access point is enabled, as discussed above. At block 330, the method may, based on a determination that the master access point can be reprogrammed with the second code version, reprogram the master access point with the second code version. At block 340, the method may send to the new access point a command to change configuration of the new access point, where the communication may include, for example, a command to reset the new access point's configuration to default factory settings, or a command to set the new access point's configuration in accordance with (e.g., to match) the master access point's configuration. At block 350, the method may reboot the master access point, causing the master access point to run the second code version after the reboot.

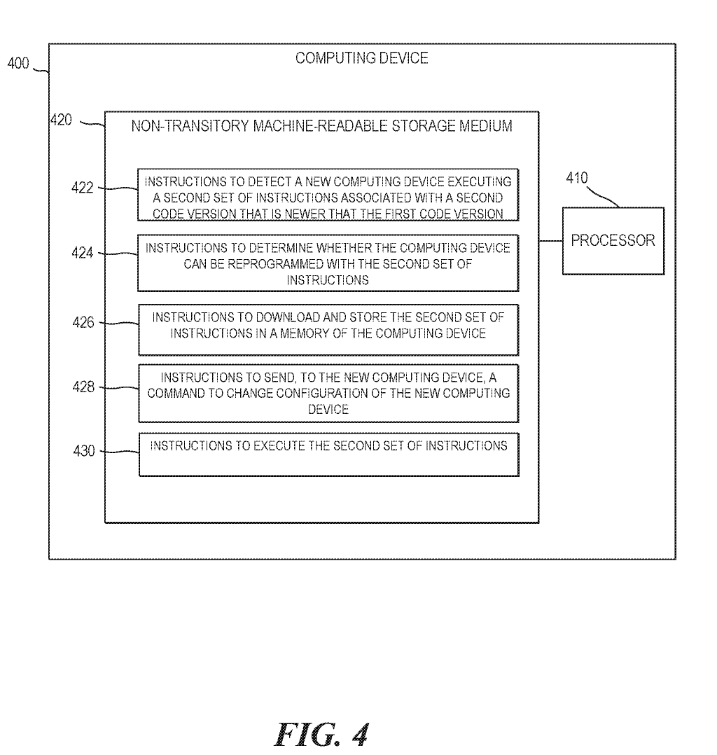

FIG. 4 is a block diagram of an example computing device 400. Computing device 400 may be similar to access point 100 of FIG. 1, or it may be any other type of electronic device capable of wireless communications. In the example of FIG. 4, computing device 400 includes a processor 410 and a non-transitory machine-readable storage medium 420. Although the following descriptions refer to a single processor and a single machine-readable storage medium, it is appreciated that multiple processors and multiple machine-readable storage mediums may be anticipated in other examples. In such other examples, the instructions may be distributed (e.g., stored) across multiple machine-readable storage mediums and the instructions may be distributed (e.g., executed by) across multiple processors.

Processor 410 may be one or more central processing units (CPUs), microprocessors, and/or other hardware devices suitable for retrieval and execution of instructions stored in non-transitory machine-readable storage medium 420. In the particular example shown in FIG. 4, processor 410 may fetch, decode, and execute a first set of instructions 422, 424, 426, 428, 430, where the first set of instructions is associated with a first code version. As an alternative or in addition to retrieving and executing instructions, processor 410 may include one or more electronic circuits comprising a number of electronic components for performing the functionality of one or more of the instructions in machine-readable storage medium 420. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Non-transitory machine-readable storage medium 420 may be any electronic, magnetic, optical, or other physical storage device that stores executable instructions. Thus, medium 420 may be, for example, Random Access Memory (RAM), an Electrically-Erasable Programmable Read-Only Memory (EEPROM), a storage drive, an optical disc, and the like. Medium 420 may be disposed within computing device 400, as shown in FIG. 4. In this situation, the executable instructions may be “installed” on computing device 400, Alternatively, medium 420 may be a portable, external or remote storage medium, for example, that allows computing device 400 to download the instructions from the portable/external/remote storage medium. In this situation, the executable instructions may be part of an “installation package.” As described herein, medium 420 may be encoded with executable instructions for finding a network device on a network,

Referring to FIG. 4, instructions 422 from the first set of instructions associated with a first code version, when executed by a processor, may cause a computing device to detect a new computing device (e.g., a new access point) executing a second set of instructions associated with a second code version that is newer that the first code version. Instructions 424, when executed by a processor, may cause the computing device to determine whether the computing device can be reprogrammed with the second set of instructions. Instructions 426, when executed by a processor, may cause the computing device to download and store the second set of instructions in a memory of the computing device based on a determination that the computing device can be reprogrammed with the second set of instructions. Instructions 428, when executed by a processor, may cause the computing device to send to the new computing device a command to change configuration of the new computing device. Instructions 430, when executed by a processor, may cause the computing device to execute the second set of instructions (e.g., by rebooting the computing device).

What is claimed is:

1. An access point programmed with a first code version, the access point comprising:
a communication interface to communicate with a second access point programmed with a second code version, and to obtain the second code version from the second access point;
a code upgrade module to:
determine, based at least on the first code version and the second version, whether the access point is to be upgraded to the second code version;
based on a determination that the access point is to be upgraded, determine whether upgrade of the access point is enabled; and
based on a determination that the access point is to be upgraded and that the upgrade of the access point is enabled, reprogram the access point with the second code version, and reboot the access point;
wherein the communication interface is further to send to the second access point a command to change configuration of the second access point before the access point is rebooted.

2. The access point of claim 1. wherein determining whether the upgrade is enabled comprises at least one of:
determining whether code associated with the second code version is downloadable to the access point;
determining whether a user-configurable setting indicates that the upgrade of the access point is allowed; and
determining whether at least one access point in a cluster of access points comprising the access point cannot be reprogrammed with the second code version.

3. The access point of claim 1, wherein the communication comprises at least one of a first command to reset the second access point to factory settings, and a second command to configure the second access point in accordance with the master configuration.

4. The access point of claim 3, wherein resetting the second access point to factory settings is to prevent the second access point from being elected as a master access point of the cluster of access points.

5. The access point of claim 1, wherein the code upgrade module is further to send a plurality of communications to a plurality of access points in the cluster of access points, wherein the plurality of communications are to cause the plurality of access points to be reprogrammed with the second code version.

6. The access point of claim 1, wherein determining that the access point is to be upgraded comprises determining whether the second code version is greater than the first code version.

7. The access point of claim 6, wherein determining that the access point is to be upgraded further comprises determining whether the second access point can be downgraded to the first code version.

8. A method comprising:
detecting, by a master access point of a cluster of access points, a new access point programmed with a second code version, wherein the master access point is programmed with a first code version that is older than the second code version;
determining whether the master access point can be reprogrammed with the second code version: and
based on a determination that the master access point can be reprogrammed with the second code version, reprogramming the master access point with the second code version, and rebooting the master access point after sending to the new access point a command to change configuration of the new access point.

9. The method of claim 8, wherein determining whether the master access point can be reprogrammed with the second code version comprises at least one of:
determining whether code associated with the second code version is downloadable to the master access point;
determining whether a user-configurable setting indicates that reprogramming the master access point with the second code version is allowed; and
determining whether at least one access point in the cluster of access points cannot be reprogrammed with the second code version.

10. The method of claim 8, further comprising determining whether the new access point can be downgraded to the first code version.

11. The method of claim 8, wherein the command to change configuration of the new access point comprises at least one of a first command to reset the new access point to factory settings and a second command to set the configuration of the new access point in accordance with configuration of the master access point.

12. A non-transitory machine-readable storage medium encoded with a first set of instructions associated with a first code version, wherein the instructions, when executed by a processor of a first computing device cause the first computing device to:
detect a second computing device executing a second set of instructions associated with a second code version that is newer that the first code version;
determine whether the first computing device can be reprogrammed with the second set of instructions;
based on a determination that the first computing device can be reprogrammed with the second set of instructions, download and store the second set of instructions in a memory of the first computing device;
send, to the new access point, a command to change configuration of the second computing device; and
execute the second set of instructions.

13. The non-transitory machine-readable storage medium of claim 12, wherein causing the first computing device to execute the second set of instructions comprises rebooting the first computing device.

14. The non-transitory machine-readable storage medium of claim 12, wherein determining whether the first computing device can be reprogrammed with the second set of instructions comprises at least one of:
determining whether the second set of instructions is downloadable to the first computing device;
determining whether a user-configurable setting indicates that reprogramming the first computing device with the second set of instructions is allowed; and
determining whether at least one computing device in a cluster of computing devices associated with the first computing device cannot be reprogrammed with the second set of instructions.

15. The non-transitory machine-readable storage medium of claim 12, wherein the command to change configuration of the new computing device comprises at least one of a first instruction to reset the new computing device to factory settings and a second instruction to set the configuration of the new computing device in accordance with configuration of the computing device.
